(19) United States
(12) Patent Application Publication
(10) Pub. No.: US 2006/0092137 A1
(43) Pub. Date: May 4, 2006

(54) Portable electronic product

(76) Inventor: Branden Lee, Jhonghe City (TW)

Correspondence Address: J C PATENTS, INC., 4 VENTURE, SUITE 250, IRVINE, CA, 92618, US

(21) Appl. No.: 10/976,104

(22) Filed: Oct. 27, 2004

(51) Int. Cl. G09G 5/00

(52) U.S. Cl. 345/173

(57) ABSTRACT

A portable electronic product comprising a main body, a display panel and a touch pad is provided. The main body comprises a top surface and a bottom surface, and the display panel is disposed on the top surface of the main body and electrically coupled thereto. Moreover, the touch pad is disposed on the bottom surface of the main body and electrically coupled thereto. Since the touch pad is disposed over the bottom surface of the main body, the display panel is not blocked while a user selects the functional options shown in the display panel. Furthermore, the user can control the portable electronic product without touching the display panel such that the damage of the display panel from frequent touching is avoided.

### BACKGROUND OF THE INVENTION

1. Field of the Invention

The present invention relates to a portable electronic product, and more particularly, to a portable electronic product with a backside touch pad using a blind positioning method for alignment.

2. Description of the Related Art

As the technology advances, people have become more and more used to electronic devices. For example, computers, audio-video products and other electronic products are ubiquitous. Therefore, electronic products have become indispensable in our daily life. With the progress of electronic technology, the electronic products have developed to be light, thin, small, user-friendly and multi-functional. Following this trend, various portable electronic products, such as mobile phones, digital cameras (DCs), personal digital assistants (PDAs) and MP3 players, have become popular items in the market.

As the described above, some portable electronic products are operated by touch pads. One of these portable electronic products is PDA. When using the portable electronic product with a touch pad, a user may use a stylus or the finger to touch the functional options displayed on the touch pad. When selecting a desired functional option, the user just touches the functional option shown on the display panel to select and execute the selected function. When using the portable electronic product, the user, however, may block a partial area of the touch pad while selecting, which is inconvenient to users. In addition, while selecting the functional options, some specific areas, such as the area near the icon, is pressed with different forces over and over. If the touch pad is frequently used, the touch pad can be easily damaged and the image quality will deteriorate.

### SUMMARY OF THE INVENTION

Accordingly, the present invention is directed to a portable electronic product. By using the blind positioning method for alignment, the touch pad is designed on the back of the product to operate the portable electronic product.

According to the object described above, the present invention provides a portable electronic product, comprising a main body, a display panel and a touch pad. Wherein, the main body has a top surface and a bottom surface. The display panel is disposed over the top surface of the main body, and electrically coupled to the main body. The touch pad is disposed over the bottom surface of the main body, and electrically coupled to the main body.

In the portable electronic product described above, the main body comprises, for example, a casing and an operating hardware. Wherein, the operating hardware is disposed inside the casing, for example. The display panel and the touch pad, for example, are electrically coupled to the operating hardware, and the display panel and the touch pad are exposed outside the casing, for example.

In the portable electronic product described above, the operating hardware can be, for example, a multi-media player, a personal digital assistant, a mobile phone, a digital camera, a digital video camera, a digital photo frame, an internet phone, a tablet personal computer or an integrated operating hardware which comprises at least two functions of the above. Wherein, the multi-media player can be, for example, a MP3 player, a CD player, a VCD player, a DVD player or a MD player.

In the portable electronic product described above, the display panel can be, for example, a liquid crystal display panel, an organic electroluminescence display panel or a field emission display panel.

In the portable electronic products described above, the touch pad comprises, for example, a plurality of touch areas, and the display panel comprises, for example, a plurality of display areas and each of the touch areas corresponds to one of the display areas. In addition, the touch pad comprises, for example, an insulating substrate and a plurality of sensing traces. Wherein, the insulating substrate, for example, has an inside surface and an outside surface. The inside surface of the insulating substrate, for example, is connected with the main body. These sensing traces, for example, are disposed over the outside surface of the insulating substrate. These sensing traces are isolated from each other, for example.

In the portable electronic products described above, the touch pad comprises, for example, a plurality of touch dots. The display panel comprises, for example, a plurality of pixels. Each of the touch dots corresponds to one of the pixels.

In the portable electronic products described above, the touch pad, for example, is the same size as the display panel. In addition, the touch pad, for example, comprises a plurality of touch areas, the display panel, for example, comprises a plurality of display areas and each of the touch areas is under one of the display areas, for example. Besides, the touch pad comprises, for example, a plurality of touch dots, and the display panel comprises, for example, a plurality of pixels and each of the touch dots is under one of the pixels, for example.

In the portable electronic products described above, the product may further comprise a mode-switching button disposed in the main body for switching to different operational modes according to a user's need.

By using the blind positioning method for alignment, the touch pad is disposed in the bottom of the main body to operate the display panel on the top of the main body. Accordingly, a user can use the touch pad to select functions displayed on the display panel without blocking the display panel. Additionally, during the operation, the user need not touch the display panel so the display panel is less likely to be damaged. In other words, the portable electronic product of the present invention can resolve the issue that the display panel may be blocked when the conventional portable electronic product with the touch screen is used. Further, the life time of the portable electronic product can also be improved.

The above and other features of the present invention will be better understood from the following detailed description of the embodiments of the invention that is provided in conjunction with the accompanying drawings.

### BRIEF DESCRIPTION OF THE DRAWINGS

FIG. 1 is a schematic configuration showing a decomposed portable electronic product according to an embodiment of the present invention.

FIGS. 2A and 2B are schematic drawings showing a top surface and a bottom surface of a portable electronic product according to an embodiment of the present invention.

FIG. 3A is a schematic drawing showing a touch pad according to another embodiment of the present invention.

FIG. 3B is a schematic drawing showing a display panel according to another embodiment of the present invention.

FIG. 4 is a schematic drawing showing a display panel with various operational modes of a portable electronic product according to an embodiment of the present invention.

FIG. 5 is a schematic configuration showing a decomposed portable electronic product according to another embodiment of the present invention.

### DESCRIPTION OF THE EMBODIMENTS

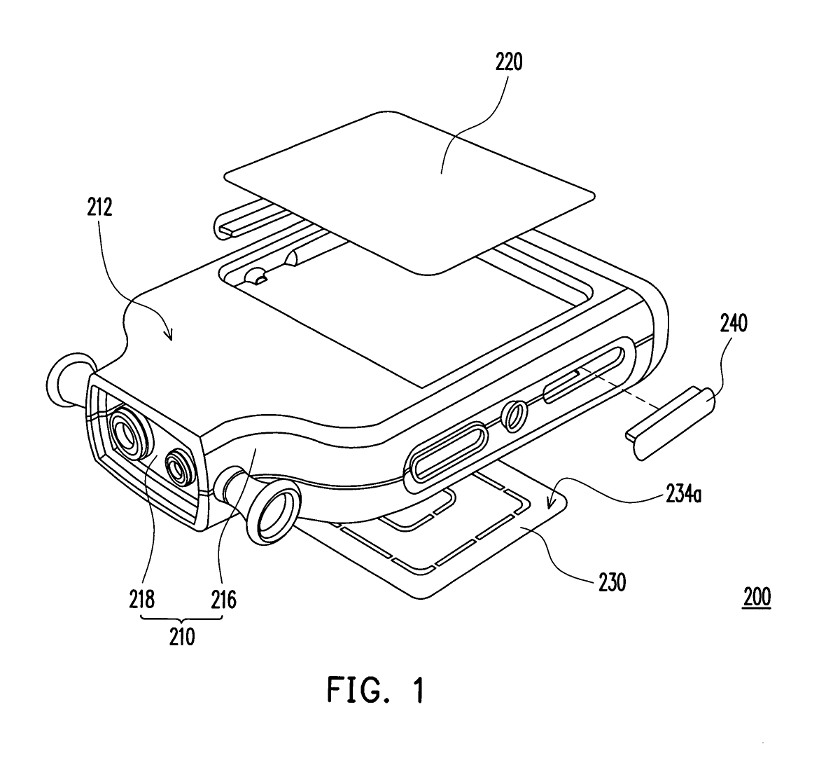

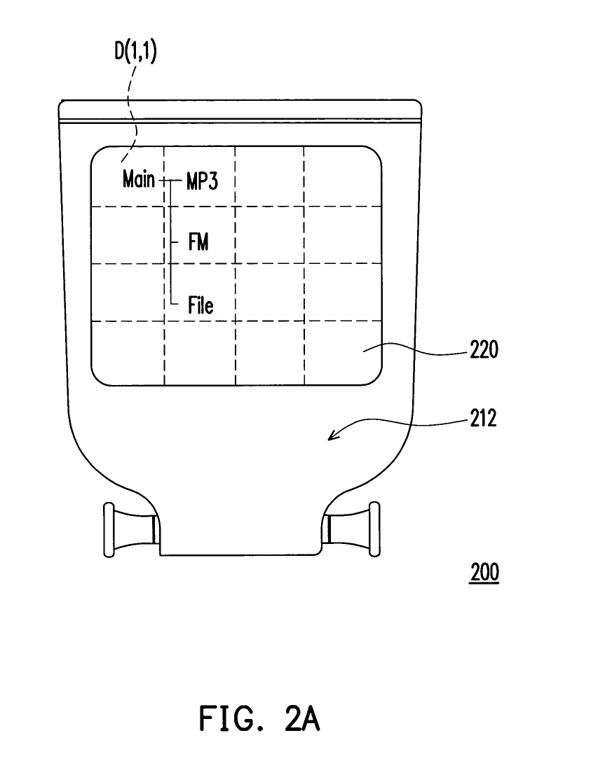

FIG. 1 is a schematic configuration showing a decomposed portable electronic product according to an embodiment of the present invention. FIGS. 2A and 2B are schematic drawings showing a top surface and a bottom surface of a portable electronic product according to an embodiment of the present invention. Referring to FIGS. 1, 2A and 2B, the portable electronic product 200 comprises a main body 210, a display panel 220 and a touch pad 230. Wherein, the main body 210 has a top surface 212 and a bottom surface 214. The display panel 220 is disposed over the top surface 212 of the main body 210, and electrically coupled to the main body 210. Additionally, the touch pad 230 is disposed over the bottom surface 214 of the main body 210, and electrically coupled to the mina body 210.

In the portable electronic product 200 described above, the main body 210 comprises, for example, a casing 216 and an operating hardware 218. Wherein, the operating hardware 218 is disposed in the casing 216, for example. The display panel 220 and the touch pad 230, for example, are electrically coupled to the operating hardware 218, and the display panel 220 and the touch pad 230 are exposed outside the casing 216, for example.

In addition, the operating hardware 210 in this embodiment is a MP3 player. The operating hardware 210, however, is not limited to the MP3 player. The operating hardware 210 can be, for example, a multi-media player, a personal digital assistant, a mobile phone, a digital camera, a digital video camera, a digital photo frame, an internet phone, or a tablet computer. Wherein, the multi-media player can be, for example, a MP3 player, a CD player, a VCD player, a DVD player or a MD player. Besides, the display panel can be, for example, a liquid crystal display panel, an organic electroluminescence display panel or a field emission display panel.

In an embodiment of the present invention, the touch pad 230 can be the same size as the display panel 220. The touch pad 230, for example, is divided into a plurality of touch areas X(1,1), X(1,2), X(1,3), X(1,n), . . . , X(2,1), X(2,2), . . . , X(m,1), X(m,2), . . . , and X(m,n). Additionally, the display panel 220 is divided into a plurality of display areas D(1,1), D(1,2), D(1,3), D(1,n), . . . ,D(2,1), D(2,2), . . . , D(m,1), D(m,2), . . . , and D(m,n). Each of the touch areas is under one of the display areas. Note that the number of the touch areas divided from the touch pad 230 can be dependent on the requirement of different products. That is, when m×n display areas are required on the display panel 220, m×n touch areas can be defined on the touch pad corresponding thereto.

In an embodiment of the present invention, the touch pad 230, for example, comprises an insulating substrate 234 and a plurality of sensing traces C(1,1), C(1,2), C(1,3), C(1,n), . . . , C(2,1), C(2,2), . . . , C(m,1), C(m,2), . . . , and C(m,n). Wherein, the insulating substrate 234, for example, has an inside surface 234a and an outside surface 234b. The inside surface 234a of the insulating substrate 234 connects with the main body 210, for example. In addition, these sensing traces C(1,1), C(1,2), C(1,3), C(1,n), . . . , C(2,1), C(2,2), . . . , C(m,1), C(m,2), . . . , and C(m,n), for example, are disposed over the outside surface 234b of the insulating substrate 234. Through the insulating substrate 234, these sensing traces C(1,1), C(1,2), C(1,3), C(1,n), . . . , C(2,1), C(2,2), . . . , C(m,1), C(m,2), . . . , and C(m,n) are electrically isolated from each other.

The following is a description of an embodiment with 4×4 touch areas, display areas and sensing traces. In this embodiment, the display area D(1,1) represents, for example, a main option. When trying to access the main option, a user can enter by touching the touch area X(1,4). More specifically, the user may, for example, move the finger on the touch pad 230. When the finger moves to the touch area X(1,4), the display area D(1,1) on the display panel 220 is lighted on, for example. At this moment, the user can, for example, tap the touch area X(1,4) twice. Meanwhile, the operating hardware 218 senses the selecting signal generated from the touch area X(1,4) through the sensing trace C(1,4) of the touch pad 230. According to the selecting signal, the operating hardware 218 executes the function displayed on the display area D(1,1). That is, the main option is accessed.

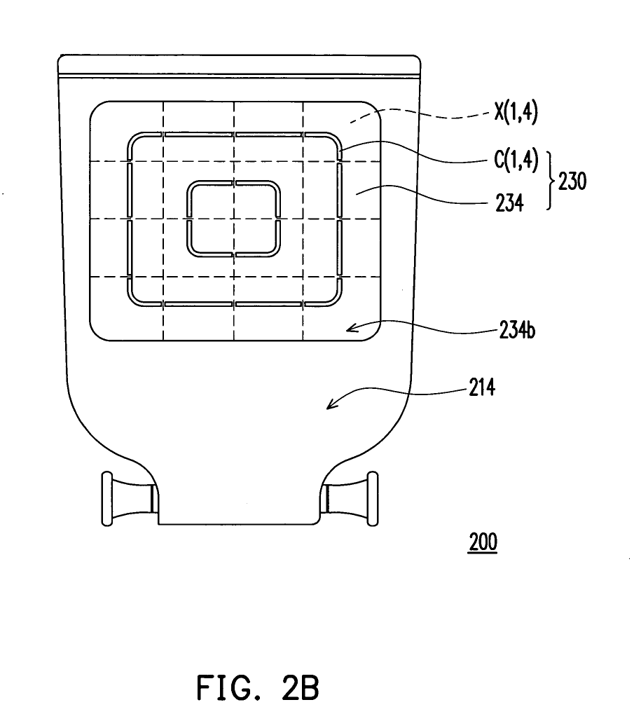

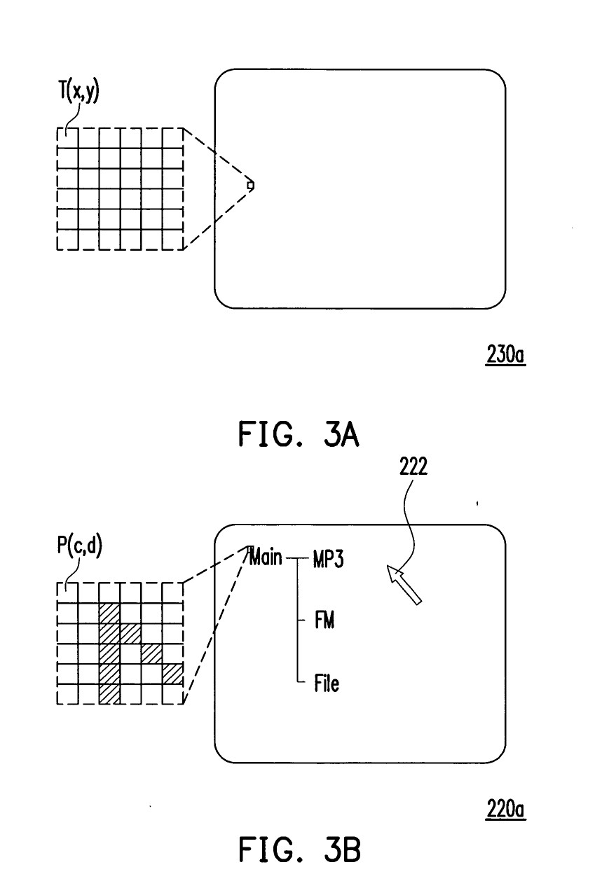

FIG. 3A is a schematic drawing showing a touch pad according to another embodiment of the present invention. FIG. 3B is a schematic drawing showing a display panel according to another embodiment of the present invention. Referring to FIGS. 3A and 3B, in this embodiment, the touch pad 230a, for example, comprises a plurality of touch areas T(1,1), T(1,2), T(1,3), T(1,n), . . . , T(2,1), T(2,2), . . . , T(m,1), T(m,2), . . . , and T(m,n); the display panel 220a can be divided into a plurality of pixels P(1,1), P(1,2), P(1,3), P(1,n), . . . ,P(2,1), P(2,2), . . . , P(m,1), P(m,2), . . . , and P(m,n). Each of the touch areas is under one of the pixels, for example. In addition, the display panel 220a, for example, comprises a cursor 222. The cursor 222 moves in correspondence with the user's finger on the touch pad 230a. When the cursor 222 moves to the functional option which the user wants to select, the user may, for example, tap the option on the touch pad 230a twice to execute the functional option.

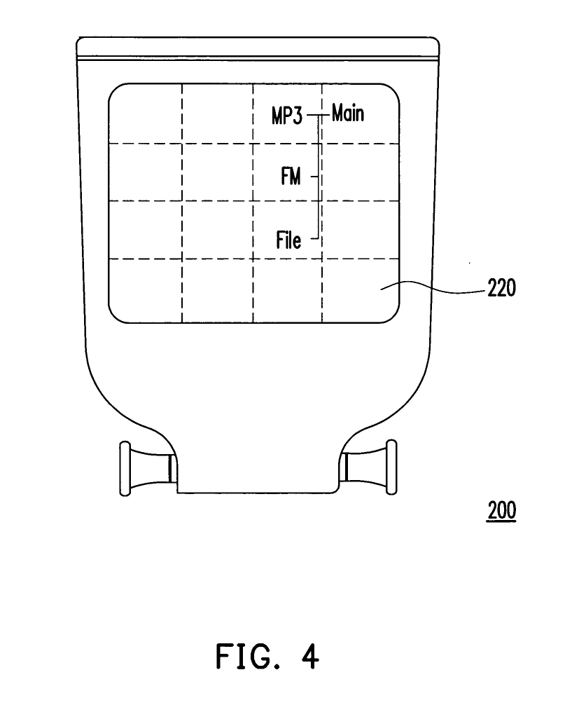

FIG. 4 is a schematic drawing showing a display panel with various operational modes of a portable electronic product according to an embodiment of the present invention. Referring to FIGS. 1, 2A and 4, the portable electronic product 200 of this embodiment further comprises a mode-switching button 240 disposed over the main body 210, for example. The mode-switching button 240 enables the user to switch the operation of the portable electronic product 200 to a different mode according to the user's need. Accordingly, users with different habits can execute the one-hand operation. In other words, the portable electronic product 200 can provide the left-hand operational mode and the right-hand operational mode, for example. When the portable electronic product 200 is in the right-hand operational mode, all functional options are shown on the left side of the display panel 220 as shown in FIG. 2A. The right-hand operational mode is suitable for right-handed users. When the mode-switching button 240 is pressed, the operational mode of the portable electronic product 200 is switched to the left-hand operational mode as shown in FIG. 4. Under this operational mode, the function options are all shown on the right side of the display panel 220. Therefore, this operational mode is suitable for left-handed users.

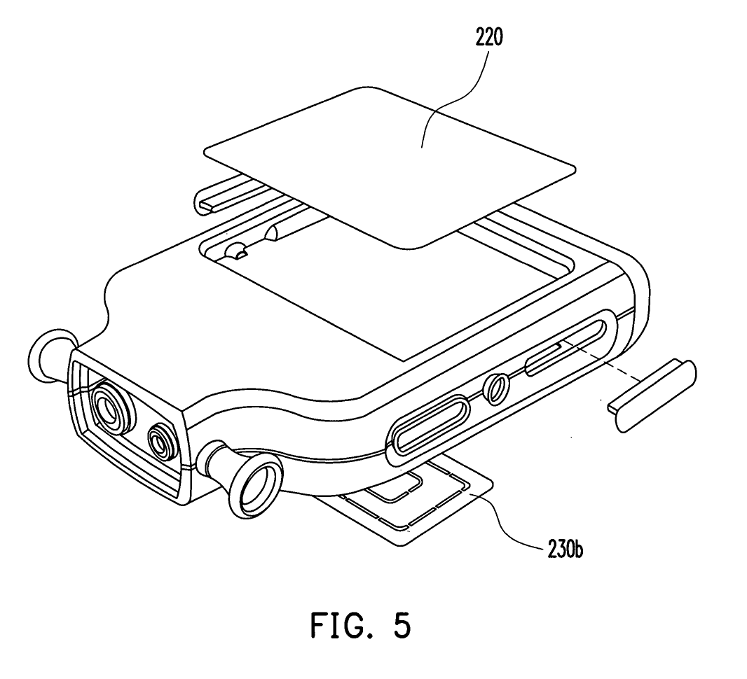

FIG. 5 is a schematic configuration showing a decomposed portable electronic product according to another embodiment of the present invention. Referring to FIG. 5, in this embodiment, the touch pad 230b can be of different size from the display panel 220. In this embodiment, the touch pad 230b is smaller than the display panel 220 as shown in FIG. 5. In this embodiment, the touch pad 230b comprises a plurality of touch areas (not shown), and the display panel 220 comprises a plurality of display areas (not shown). Each of the touch areas is not exactly under one of the display areas, but corresponds to one of the display areas. Moreover, if the touch pad 230b comprises a plurality of touch dots, and the display panel 220 comprises a plurality of pixels, each of the touch dots is not exactly under one of the pixels, but corresponds to one of the pixels. Further, the operation of the portable electronic product comprising the touch pad and the display panel having different sizes is similar to that of the embodiment described above. Detailed descriptions are not repeated.

Accordingly, the portable electronic product of the present invention adopts the blind positioning method for alignment in which the touch pad is disposed under the bottom of the main body and the display panel is disposed over the top of the main body, and various functional options displayed on the display panel are executed on the touch pad. Accordingly, the touch pad is used to select functions displayed on the display panel and the user's view will not be blocked. Additionally, during the operation, the user need not touch the display panel, so the display panel is less likely to be damaged. In other words, with the portable electronic product of the present invention, the user's view will not be blocked when using the portable electronic product with the touch screen, which is more convenient for users. Also, the damage of the display panel and deteriorated image quality caused by frequent touching can be avoided.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A portable electronic product, comprising:
a main body having a top surface and a bottom surface;
a display panel disposed over the top surface of the main body, and electrically coupled to the main body; and
a touch pad disposed over the bottom surface of the main body, and electrically coupled to the main body.

2. The portable electronic product of claim 1, wherein the main body comprises:
a casing; and
an operating hardware disposed in the casing, wherein the display panel and the touch pad are electrically coupled to the operating hardware, and the display panel and the touch pad are exposed outside the casing.

3. The portable electronic product of claim 2, wherein the operating hardware is a multi-media player, a personal digital assistant, a mobile phone, a digital camera, a digital video camera, a digital photo frame, an internet phone or a tablet computer.

4. The portable electronic product of claim 3, wherein the multi-media player comprises a MP3 player, a CD player, a VCD player, a DVD player or a MD player.

5. The portable electronic product of claim 1, wherein the display panel comprises a liquid crystal display panel, an organic electroluminescence display panel or a field emission display panel.

6. The portable electronic product of claim 1, wherein the touch pad comprises a plurality of touch areas, and the display panel comprises a plurality of display areas and each of the touch areas corresponds to one of the display areas.

7. The portable electronic product of claim 6, wherein the touch pad comprises:
an insulating substrate having an inside surface and an outside surface, the inside surface of the insulating substrate connecting with the main body; and
a plurality of sensing traces disposed over the outside surface of the insulating substrate, wherein the sensing traces are isolated from each other.

8. The portable electronic product of claim 1, wherein the touch pad comprises a plurality of touch dots, and the display panel comprises a plurality of pixels and each of the touch dots corresponds to one of the pixels.

9. The portable electronic product of claim 1, wherein the touch pad is of the same size as the display panel.

10. The portable electronic product of claim 9, wherein the touch pad comprises a plurality of touch areas, and the display panel comprises a plurality of display areas and each of the touch areas is under one of the display areas.

11. The portable electronic product of claim 9, wherein the touch pad comprises a plurality of touch dots, and the display panel comprises a plurality of pixels and each of the touch dots is under one of the pixels.

12. The portable electronic product of claim 1, further comprising a mode-switching button, disposed over the main body for switching to different operational modes according to a user's need.
